(19) United States
(12) Patent Application Publication
(10) Pub. No.: US 2014/0030617 A1
(43) Pub. Date: Jan. 30, 2014

(54) FUEL REFORMER FOR FUEL CELL

(71) Applicants: Ruey Jong Shyu, Taoyuan Hsien (TW); Ming Chuan Su, Taoyuan Hsien (TW); Hsien Sou Han, Taoyuan Hsien (TW)

(72) Inventors: Ruey Jong Shyu, Taoyuan Hsien (TW); Ming Chuan Su, Taoyuan Hsien (TW); Hsien Sou Han, Taoyuan Hsien (TW)

(21) Appl. No.: 13/556,269

(22) Filed: Jul. 24, 2012

(51) Int. Cl. H01M 8/06

(52) U.S. Cl. 429/423

(57) ABSTRACT

A fuel reformer includes a primary carrier having a chamber between two separated protrusions for receiving a fuel material, two orifices formed in the protrusions, and two apertures communicative with the chamber of the primary carrier, and a secondary carrier disposed below the primary carrier and having a compartment formed between two separated swellings for receiving a regulating fluid and having two holes formed in the swellings and communicative with the apertures of the primary carrier, and the orifices of the protrusions are communicative with the compartment of the secondary carrier for allowing the regulating fluid to flow through the orifices of the primary carrier and the compartment of the secondary carrier.

### BACKGROUND OF THE INVENTION

1. Field of the Invention

The present invention relates to a fuel reformer or fuel processor, and more particularly to a fuel reformer or fuel processor including a plate type structure for allowing the fuel gas or material to be effectively supplied or flown through the gas passage of the fuel reformer or fuel processor, and for allowing the fuel gas or material to be effectively act with the catalyst to generate a hydrogen rich gas or reformed gas having a great percentage of hydrogen.

2. Description of the Prior Art

Various kinds of typical fuel reformers or fuel processors have been developed and provided for generating and providing or supplying a reformed or hydrogen rich gas that includes a great percentage of hydrogen to a fuel cell, such as the solid oxide fuel cell, the proton exchange membrane fuel cell etc., and the typical fuel reformers or fuel processors normally comprise a housing or receptacle for receiving or accommodating the catalyst, an inlet for filling or supplying a natural gas, methyl alcohol, or the like into the housing or receptacle and for acting with the catalyst and for forming the reformed or hydrogen rich gas, and an outlet for supplying the reformed or hydrogen rich gas to the fuel cell.

For example, U.S. Pat. No. 4,820,314 to Cohen et al., U.S. Pat. No. 5,651,800 to Mizuno et al., U.S. Pat. No. 6,284,398 to Kiryu, U.S. Pat. No. 6,887,286 to Taki et al., U.S. Pat. No. 7,141,223 to Kadowaki et al., U.S. Pat. No. 7,682,587 to Kong et al., and U.S. Pat. No. 7,691,509 to Han et al. disclose several of the typical fuel reformers or fuel processors for generating and providing or supplying the reformed or hydrogen rich gas to the fuel cell.

However, the typical fuel reformers or fuel processors normally comprise a structure that the filled or supplied natural gas, such as methyl alcohol, or the like should flow through a predetermined flowing passage and may not be effectively act with the catalyst to generate the hydrogen rich gas or reformed gas, and normally comprise a large volume that may not be easily and quickly manufactured and assembled. In addition, one or more of the typical fuel reformers or fuel processors may not be easily and quickly assembled or connected or coupled together.

The present invention has arisen to mitigate and/or obviate the afore-described disadvantages of the conventional fuel reformers or fuel processors.

### SUMMARY OF THE INVENTION

The primary objective of the present invention is to provide a fuel reformer including a plate type structure for allowing the fuel gas or material to be effectively supplied or flown through the gas passage of the fuel reformer or fuel processor, and for allowing the fuel gas or material to be effectively act with the catalyst to generate a hydrogen rich gas or reformed gas having a great percentage of hydrogen.

The other objective of the present invention is to provide a fuel reformer including a number of units each of which include a compact and simplified structure for allowing the units to be easily and quickly and readily connected or coupled together.

In accordance with one aspect of the invention, there is provided a fuel reformer comprising a first primary carrier including a first protrusion and a second protrusion separated from each other for forming a chamber between the first and the second protrusions and for receiving a fuel material, and including a first orifice and a second orifice formed in the first and the second protrusions respectively, and including a first aperture and a second aperture formed therein and communicative with the chamber of the first primary carrier, and the chamber of the first primary carrier forming a primary fluid flowing path, and a first secondary carrier disposed below the first primary carrier and including a first swelling and a second swelling separated from each other for forming a compartment between the first and the second swellings and for receiving a regulating fluid, and including a first hole and a second hole formed in the first and the second swellings respectively and aligned with and communicative with the first and the second apertures of the first primary carrier respectively, and the first and the second orifices of the first and the second protrusions being communicative with the compartment of the first secondary carrier for allowing the regulating fluid to flow through the first orifice of the first primary carrier and into the compartment of the first secondary carrier and then to flow out through the second orifice of the first primary carrier, and the first and the second orifices of the first and the second protrusions of the first primary carrier and the compartment of the first secondary carrier forming a secondary fluid flowing path.

The first secondary carrier includes at least one bulge extended upwardly into the compartment thereof and secured to the first primary carrier. A second primary carrier may further be provided and disposed below the first secondary carrier and including a third protrusion and a fourth protrusion separated from each other for forming a chamber between the third and the fourth protrusions of the second primary carrier, and the chamber of the second primary carrier being communicative with the first and the second holes of the first and the second swellings respectively for the fuel material to flow into and out of the chamber of the second primary carrier.

The second primary carrier includes a third orifice and a fourth orifice formed in the third and the fourth protrusions respectively, and the third and the fourth protrusions are attached to bottom of the first secondary carrier, and the first secondary carrier includes a first pathway and a second pathway formed therein and communicative with the compartment of the first secondary carrier and aligned with and communicative with the third and the fourth orifices of the third and the fourth protrusions respectively.

The second primary carrier includes a third aperture and a fourth aperture formed therein and communicative with the chamber of the second primary carrier, and the chambers of the first and the second primary carriers and the first and the second holes of the first and the second swellings form the primary fluid flowing path.

A second secondary carrier may further be provided and disposed below the second primary carrier and includes a third swelling and a fourth swelling separated from each other for forming a compartment between the third and the fourth swellings, and includes a third hole and a fourth hole formed in the third and the fourth swellings respectively and aligned with and communicative with the third and the fourth apertures of the second primary carrier respectively.

A lower panel may further be provided and disposed below the second secondary carrier. The second secondary carrier includes at least one bulge extended upwardly into the compartment thereof and secured to the second primary carrier. The second primary carrier includes at least one projection extended upwardly into the chamber thereof and secured to the first secondary carrier.

A cover may further be provided and disposed above the first primary carrier, and the cover includes an inlet and an outlet communicative with the chamber of the first primary carrier, and an entrance and an exit communicative with the first and the second orifices of the first and the second protrusions of the first primary carrier. The first primary carrier includes at least one projection extended upwardly into the chamber thereof and secured to the cover.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view illustrating the connecting or coupling of two or more fuel reformers or fuel processors in accordance with the present invention;

FIG. 2 is an upper perspective view of the fuel reformer or fuel processor;

FIG. 3 is an exploded view of the fuel reformer or fuel processor;

FIG. 4 is another exploded view of the fuel reformer or fuel processor, in which one half of the fuel reformer or fuel processor has been cut off for showing the inner structure of the fuel reformer or fuel processor;

FIG. 5 is a partial cross sectional view of the fuel reformer or fuel processor, taken along lines 5-5 of FIG. 2;

FIG. 6 is a partial cross sectional view similar to FIG. 5, illustrating the operation of the fuel reformer or fuel processor;

FIG. 7 is an upper perspective view illustrating the other arrangement of the fuel reformer or fuel processor;

FIG. 8 is another exploded view similar to FIG. 3, illustrating the further arrangement of the fuel reformer or fuel processor;

FIG. 9 is another exploded view similar to FIGS. 3 and 8, illustrating the still further arrangement of the fuel reformer or fuel processor; and

FIG. 10 is a partial perspective view illustrating the fuel reformer or fuel processor as shown in FIG. 9.

### DETAILED DESCRIPTION OF THE PREFERRED EMBODIMENT

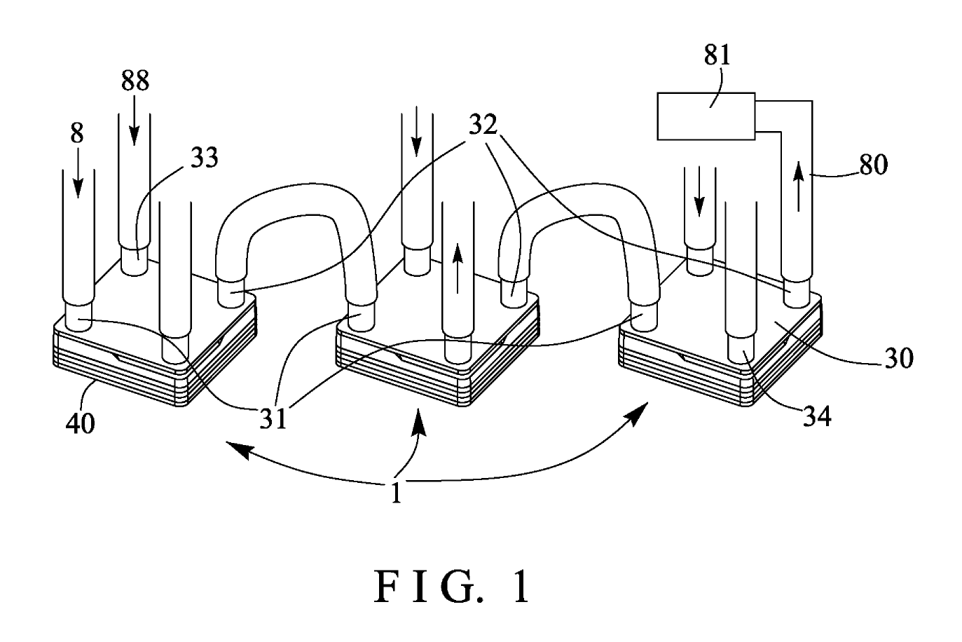

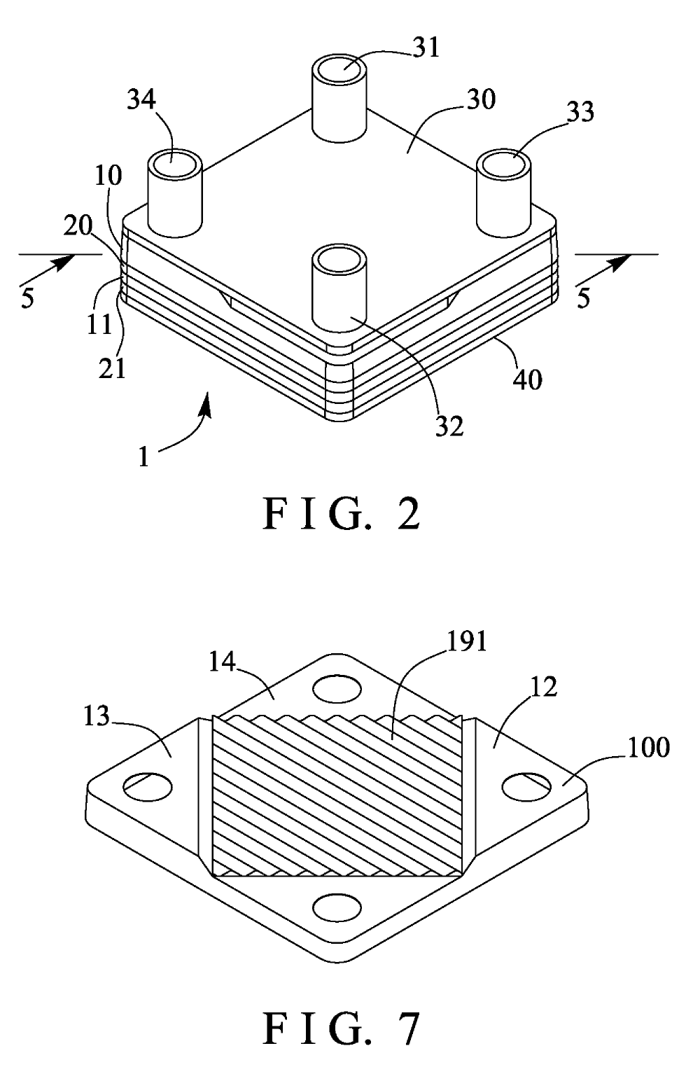

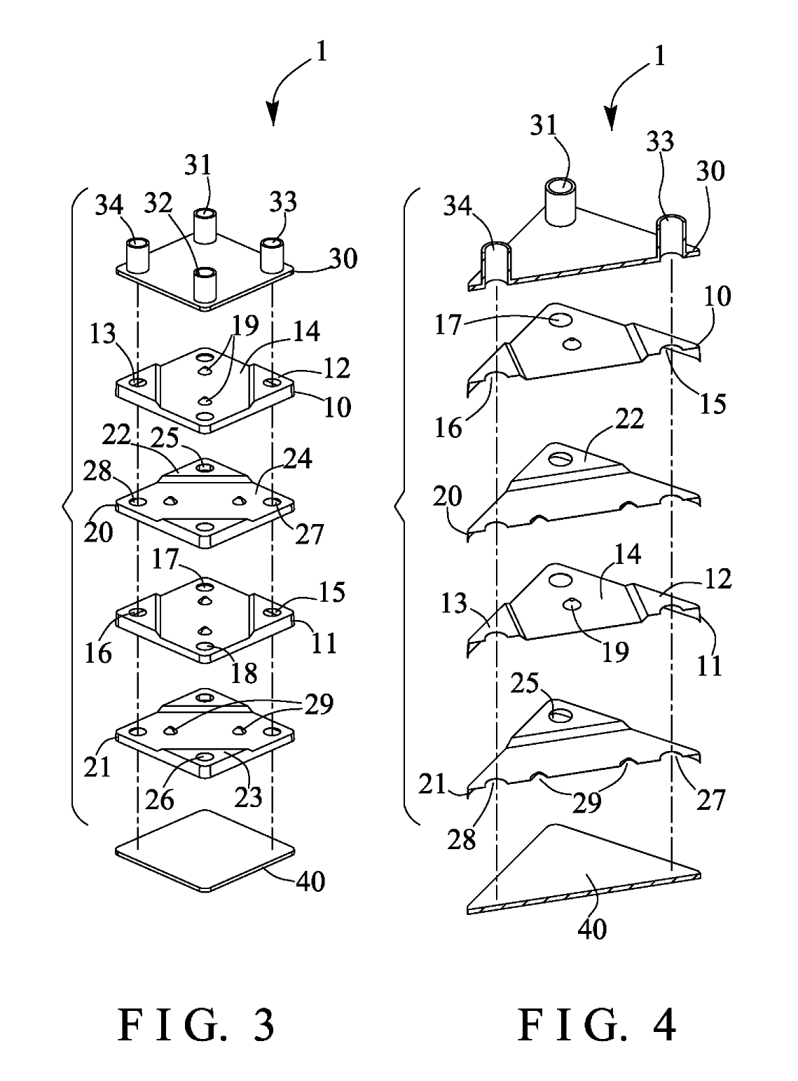

Referring to the drawings, and initially to FIGS. 1-2, a fuel reformer system or assembly in accordance with the present invention comprises one or more units of fuel processors or fuel reformers 1 to be easily and quickly and readily connected or coupled together, in which one of the fuel reformers 1 will be discussed hereinafter. As shown in FIGS. 2-6, each of the fuel reformers 1 include one or more (such as two) primary or first platforms or partitions or carriers 10, 11, and one or more (such as two) secondary or second platforms or partitions or carriers 20, 21 disposed or arranged or located alternatively, for example, the upper secondary or second carrier 20 is disposed or arranged or located between the upper and the lower primary or first carriers 10, 11, and the lower carrier 11 is disposed or arranged or located between the upper and the lower secondary or second carriers 20, 21, etc., and the fuel reformer 1 may selectively include two or more primary or first carriers 10, 11 and two or more secondary or second carriers 20, 21.

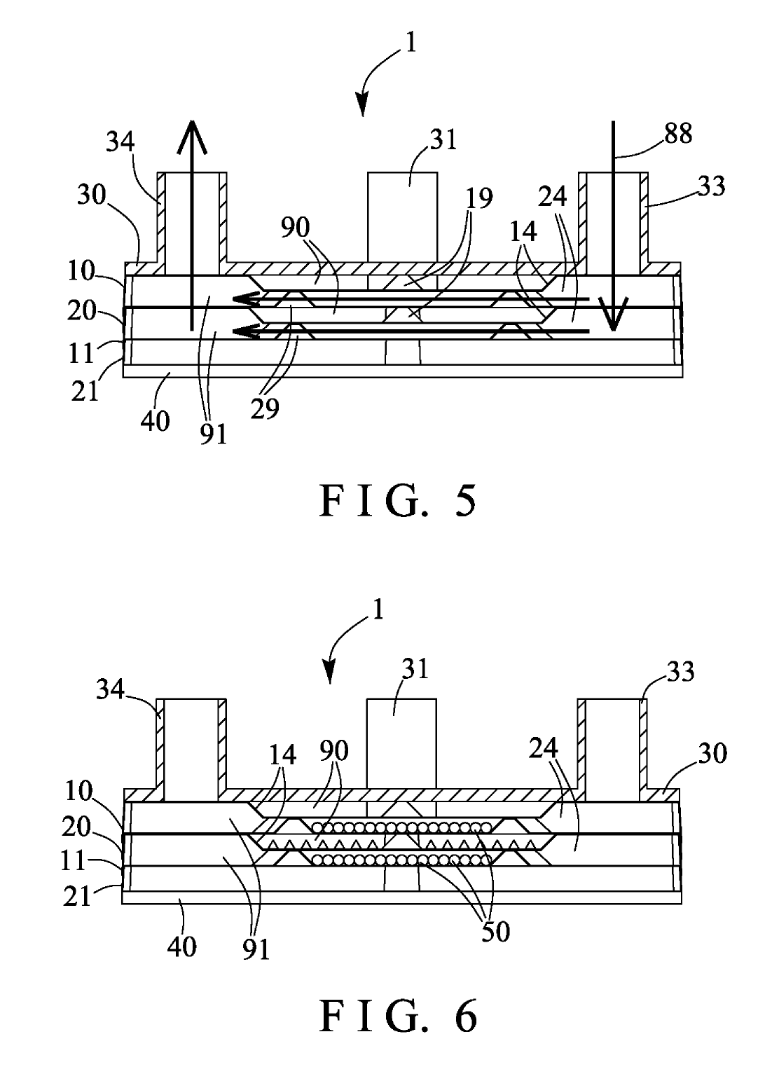

The fuel reformer 1 further includes an upper plate or cover 30 to be arranged or located or disposed above the carriers 10, 11, 20, 21, and a lower plate or cover or panel 40 to be arranged or located or disposed below or beneath the carriers 10, 11, 20, 21, in which the upper cover 30 includes an inlet 31 for filling or supplying a fuel gas or material 8 (FIG. 1), such as natural gas, methyl alcohol, or the like into the fuel reformer 1, an outlet 32 for supplying the reformed or hydrogen rich gas 80 out of the fuel reformer 1 and into the fuel cell 81, an entrance 33 for filling or supplying a regulating air or water or fluid 88 (FIGS. 1, 5) into the fuel reformer 1, and an exit 34 for supplying the regulating fluid 88 out of the fuel reformer 1. As shown in FIG. 1, the outlet 32 of the frontmost fuel reformer 1 may be coupled to the inlet 31 of the other fuel reformers 1, and the inlet 31 of the last fuel reformer 1 may be coupled to the outlet 32 of the other fuel reformers 1.

The primary or first carriers 10, 11 each include two or first and second bulges or swellings or protrusions 12, 13 separated from each other for forming or defining a depression or space or chamber 14 between the protrusions 12, 13, and the protrusions 12, 13 of the primary or first carriers 10, 11 are disposed or arranged or located below or beneath the entrance 33 and the exit 34 of the cover 30 respectively, and each include a passage or first or second orifice 15, 16 formed therein and aligned with or communicative with the entrance 33 and the exit 34 of the cover 30 respectively, and the primary or first carriers 10, 11 each include two or first and second passages or apertures 17, 18 formed therein and communicative with the chamber 14 thereof, and each include one or more (such as two) protrusions or bulges or swellings or projections 19 extended upwardly into the chamber 14 thereof, in which the protrusions 12, 13 and/or the projections 19 of the upper primary carrier 10 may be adhered or welded or secured or vacuum brazed to the bottom of the cover 30.

The secondary or second carriers 20, 21 each include two or first and second bulges or protrusions or swellings 22, 23 separated from each other for forming or defining a depression or chamber or space or compartment 24 between the swellings 22, 23, and the swellings 22, 23 of the secondary or second carriers 20, 21 are disposed or arranged or located below or beneath the inlet 31 and the outlet 32 of the cover 30 respectively and may be adhered or welded or secured or vacuum brazed to the bottom of the primary or first carriers 10, 11 respectively, and the swellings 22, 23 of the secondary or second carriers 20, 21 each include a passage or first or second orifice or hole 25, 26 formed therein and aligned with or communicative with the apertures 17, 18 of the primary or first carriers 10, 11 respectively, and the secondary or second carriers 20, 21 each include two or first and second passages or pathways 27, 28 formed therein and communicative with the compartment 24 thereof and disposed or arranged or located below or beneath the entrance 33 and the exit 34 of the cover 30 and the orifices 15, 16 of the protrusions 12, 13 of the primary or first carriers 10, 11 respectively.

The secondary or second carriers 20, 21 each may further include one or more (such as two) protrusions or swellings or projections or bulges 29 extended upwardly into the compartment 24 thereof, in which the swellings 22, 23 and/or the bulges 29 of the secondary or second carriers 20, 21 may be adhered or welded or secured or vacuum brazed to the bottom of the primary carriers 10, 11 with adhesive materials, laser welders, arc welders, vacuum brazings, or the like, and the lower plate or panel 40 may be adhered or welded or secured or vacuum brazed to the bottom of the lowest or bottommost secondary or second carrier 21, such that the cover 30 and the carriers 10, 11, 20, 21 and the lower panel 40 may be secured and connected or coupled together to form a unitary fuel reformer 1, and two or more fuel reformers 1 may then be connected or coupled together (FIG. 1) to form a fuel reformer system or assembly or combination.

The fuel gas or material 8, such as natural gas, methyl alcohol, or the like filled or supplied into the inlet 31 of the cover 30 may thus flow into the chamber 14 of the upper primary carrier 10, and may then flow through the apertures 17, 18 of the upper primary carrier 10 and the hole 25, 26 of the swellings 22, 23 of the upper secondary carrier 20 respectively, and may then flow into the chamber 14 of the lower primary carrier 11, and may then flow through the apertures 17, 18 of the lower primary carrier 11 and the hole 25, 26 of the swellings 22, 23 of the lower secondary carrier 21 respectively, and may then flow into the chamber 14 of the further lower primary carrier (not shown) that is disposed or arranged or located below or beneath the lower secondary carrier 21, and may then flow out through the outlet 32 of the cover 30, and the inlet 31 of the cover 30 and the chambers 14 of the primary carriers 10, 11 may thus be formed as a primary gas or fuel or fluid flowing path 90 (FIGS. 5, 6).

The fuel gas or material 8 supplied into the inlet 31 of the cover 30 and into the primary fluid flowing path 90 may be conducted or subjected with a steam reforming (SR) which may absorb the heat from the environment, a water gas shift (WGS) or a preferential oxidation (PrOX) which may release the heat to the environment, or the like. The regulating air or water or fluid 88 filled or supplied into the entrance 33 of the cover 30 may flow through the orifice 15 in one of the protrusions 12 of the upper primary carrier 10, and into the compartment 24 of the upper secondary carrier 20, and may then flow out through the orifice 16 in the other protrusion 13 of the upper primary carrier 10 and the exit 34 of the cover 30.

Some of the regulating fluid 88 may also flow through the pathway 27 of the upper secondary carrier 20 and the orifice 15 in one of the protrusions 12 of the lower primary carrier 11 and into the compartment 24 of the lower secondary carrier 21, and may then flow through the orifice 16 in the other protrusion 13 of the lower primary carrier 11 and through the pathway 28 of the upper secondary carrier 20 and into the compartment 24 of the upper secondary carrier 20, and may then flow out through the orifice 16 in the other protrusion 13 of the upper primary carrier 10 and the exit 34 of the cover 30, and the entrance 33 of the cover 30 and the orifices 15, 16 of the primary carriers 10, 11 and the compartments 24 and the pathways 27, 28 of the secondary carriers 20, 21, and the exit 34 of the cover 30 may thus be formed as a secondary gas or fuel or fluid flowing path 91.

The regulating fluid 88 may be provided or used to provide and supply the heat into the secondary gas or fuel or fluid flowing path 91 for heat exchanging with the fuel gas or material 8 that is conducted or subjected with the steam reforming (SR), for example, as shown in FIG. 6, a number of catalyst materials or members or particles 50 may be provided and disposed or received or engaged in the compartments 24 of the secondary carriers 20, 21 for operating or conducting as a catalytic combustion or the like and for releasing the heat into the secondary gas or fuel or fluid flowing path 91. When the fuel gas or material 8 is conducted or subjected with the water gas shift (WGS) or the preferential oxidation (PrOX), a cooling gas or air or fluid may be provided or filled or supplied into the secondary gas or fuel or fluid flowing path 91 for heat exchanging with the fuel gas or material 8 that is conducted or subjected with the water gas shift (WGS) or the preferential oxidation (PrOX) and for absorbing the heat from the fuel gas or material 8.

It is to be noted that the chambers 14 of the primary carriers 10, 11 and/or the primary gas or fuel or fluid flowing path 90 of the primary carriers 10, 11 that is provided for the fuel gas or material 8 to flow therein or therethrough is separated from or offset from the compartments 24 of the secondary carriers 20, 21 and/or the secondary gas or fuel or fluid flowing path 91 of the secondary carriers 20, 21 that is provided for the regulating fluid 88 to flow therein or therethrough, such that the primary gas or fuel or fluid flowing path 90 of the primary carriers 10, 11 and the secondary gas or fuel or fluid flowing path 91 of the secondary carriers 20, 21 are two different or separated or offset fluid flowing passages or pathways or the like that are not communicative with each other.

Without the cover 30, the fuel gas or material 8 may also be directly flow into the chamber 14 of the upper primary carrier 10, and may then flow through the apertures 17, 18 of the upper primary carrier 10 and the hole 25, 26 of the swellings 22, 23 of the upper secondary carrier 20 respectively, and may then flow into the chamber 14 of the lower primary carrier 11. The regulating fluid 88 may also be directly flow into orifice 15 in one of the protrusions 12 of the upper primary carrier 10, and into the compartment 24 of the upper secondary carrier 20, and may then flow out through the orifice 16 in the other protrusion 13 of the upper primary carrier 10, and some of the regulating fluid 88 may also flow through the pathway 27 of the upper secondary carrier 20 and the orifice 15 in one of the protrusions 12 of the lower primary carrier 11 and into the compartment 24 of the lower secondary carrier 21, and may then flow through the orifice 16 in the other protrusion 13 of the lower primary carrier 11 and through the pathway 28 of the upper secondary carrier 20 and into the compartment 24 of the upper secondary carrier 20, and may then flow out through the orifice 16 in the other protrusion 13 of the upper primary carrier 10.

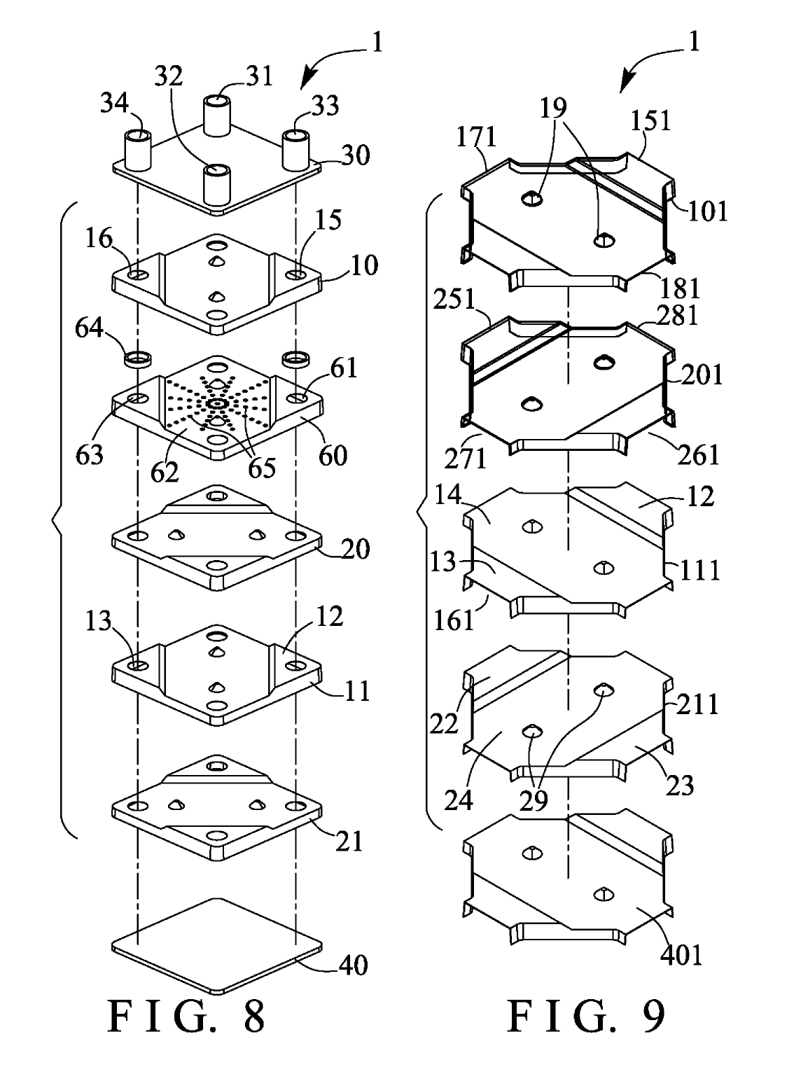

Alternatively, as shown in FIG. 7, the secondary and/or the primary carriers 100 may include a number of protrusions or bulges or swellings or projections 191, such as wavy shaped projections 191 having different shapes or structures or configurations. Further alternatively, as shown in FIG. 8, an additional carrier 60 may further be provided and disposed or engaged between the upper primary and secondary carriers 10, 20, and includes two bulges or swellings or protrusions 61 for forming or defining a depression or space or chamber 62 between the protrusions 61 for receiving or accommodating the catalyst, and the protrusions 61 of the additional carrier 60 each include an orifice 63 disposed or arranged or located below or beneath and aligned with or communicative with the orifice 15, 16 of the upper primary carrier 10, and two gaskets or sealing rings 64 disposed between orifices 15, 16, 63 of the carriers 10, 60, and the additional carrier 60 includes a number of orifices or apertures or holes or perforations 65 formed therein for allowing the air or gas or water or fluid to flow through the perforations 65 of the additional carrier 60.

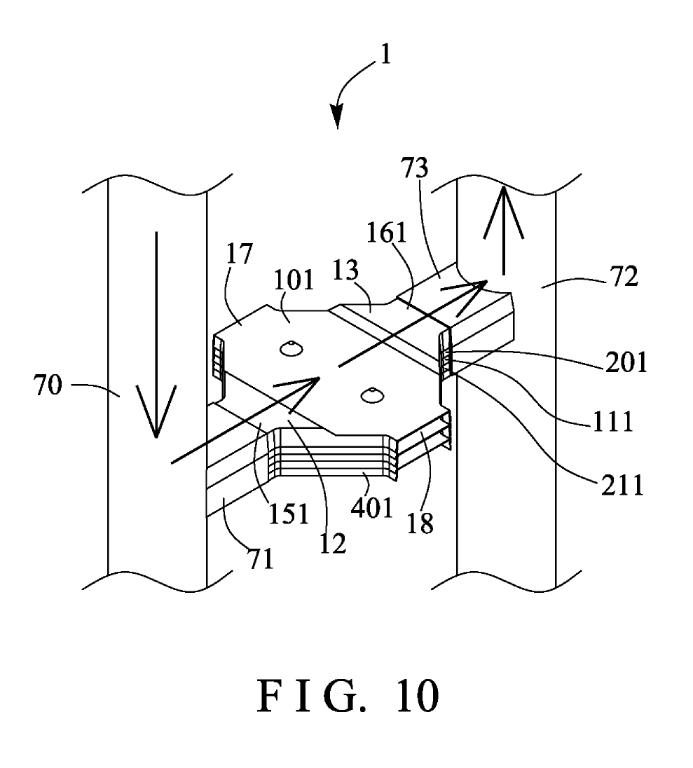

Further alternatively, as shown in FIGS. 9 and 10, the primary carriers 101, 111 may include similar protrusions 12, 13 for forming or defining a chamber 14 between the protrusions 12, 13, and the protrusions 12, 13 of the primary carriers 101, 111 each include an orifice or opening 151, 161 formed therein and act as an inlet 151 and an outlet 161 respectively, the inlets 151 are provided for connecting or coupling to the mouth 71 of an inlet pipe 70 and for receiving the fuel gas or material from the inlet pipe 70, and the outlets 161 are provided for connecting or coupling to the mouth 73 of the outlet pipe 72. The primary carriers 101, 111 each may further include two apertures 171, 181 formed therein and act as an entrance 171 and an exit 181 for the regulating fluid to flow into and out of the primary carriers 101, 111.

The secondary carriers 201, 211 each may include similar swellings 22, 23 for forming or defining a compartment 24 between the swellings 22, 23, and the swellings 22, 23 each include a hole 251, 261 formed therein and act as an entrance 251 and an exit 261 for the regulating fluid to flow into and out of the secondary carriers 201, 211, and each include two pathways 271, 281 formed therein and act as an inlet 271 and an outlet 281 respectively, the inlets 271 are provided for connecting or coupling to the mouth 71 of the inlet pipe 70 and for receiving the fuel gas or material from the inlet pipe 70, and the outlets 281 are provided for connecting or coupling to the mouth 73 of the outlet pipe 72.

Accordingly, the fuel reformer in accordance with the present invention includes a plate type structure for allowing the fuel gas or material to be effectively supplied or flown through the gas passage of the fuel reformer or fuel processor, and for allowing the fuel gas or material to be effectively act with the catalyst to generate a hydrogen rich gas or reformed gas having a great percentage of hydrogen, and includes a number of units each of which include a compact and simplified structure for allowing the units to be easily and quickly and readily connected or coupled together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fuel reformer comprising:
a first primary carrier including a first protrusion and a second protrusion separated from each other for forming a chamber between said first and said second protrusions and for receiving a fuel material, and including a first orifice and a second orifice formed in said first and said second protrusions respectively, and including a first aperture and a second aperture formed therein and communicative with said chamber of said first primary carrier, and said chamber of said first primary carrier forming a primary fluid flowing path, and
a first secondary carrier disposed below said first primary carrier and including a first swelling and a second swelling separated from each other for forming a compartment between said first and said second swellings and for receiving a regulating fluid, and including a first hole and a second hole formed in said first and said second swellings respectively and aligned with and communicative with said first and said second apertures of said first primary carrier respectively, and said first and said second orifices of said first and said second protrusions being communicative with said compartment of said first secondary carrier for allowing the regulating fluid to flow through said first orifice of said first primary carrier and into said compartment of said first secondary carrier and then to flow out through said second orifice of said first primary carrier, and said first and said second orifices of said first and said second protrusions of said first primary carrier and said compartment of said first secondary carrier forming a secondary fluid flowing path.

2. The fuel reformer as claimed in claim 1, wherein said first secondary carrier includes at least one bulge extended upwardly into said compartment thereof and secured to said first primary carrier.

3. The fuel reformer as claimed in claim 1 further comprising a second primary carrier disposed below said first secondary carrier and including a third protrusion and a fourth protrusion separated from each other for forming a chamber between said third and said fourth protrusions of said second primary carrier, and said chamber of said second primary carrier being communicative with said first and said second holes of said first and said second swellings respectively for the fuel material to flow into and out of said chamber of said second primary carrier.

4. The fuel reformer as claimed in claim 3, wherein said second primary carrier includes a third orifice and a fourth orifice formed in said third and said fourth protrusions respectively, and said third and said fourth protrusions are attached to bottom of said first secondary carrier, and said first secondary carrier includes a first pathway and a second pathway formed therein and communicative with said compartment of said first secondary carrier and aligned with and communicative with said third and said fourth orifices of said third and said fourth protrusions respectively.

5. The fuel reformer as claimed in claim 3, wherein said second primary carrier includes a third aperture and a fourth aperture formed therein and communicative with said chamber of said second primary carrier, and said chambers of said first and said second primary carriers and said first and said second holes of said first and said second swellings form said primary fluid flowing path.

6. The fuel reformer as claimed in claim 5, wherein a second secondary carrier is disposed below said second primary carrier and includes a third swelling and a fourth swelling separated from each other for forming a compartment between said third and said fourth swellings, and includes a third hole and a fourth hole formed in said third and said fourth swellings respectively and aligned with and communicative with said third and said fourth apertures of said second primary carrier respectively.

7. The fuel reformer as claimed in claim 6, wherein a lower panel is disposed below said second secondary carrier.

8. The fuel reformer as claimed in claim 6, wherein said second secondary carrier includes at least one bulge extended upwardly into said compartment thereof and secured to said second primary carrier.

9. The fuel reformer as claimed in claim 3, wherein said second primary carrier includes at least one projection extended upwardly into said chamber thereof and secured to said first secondary carrier.

10. The fuel reformer as claimed in claim 1, wherein a cover is disposed above said first primary carrier, and said cover includes an inlet and an outlet communicative with said chamber of said first primary carrier, and an entrance and an exit communicative with said first and said second orifices of said first and said second protrusions of said first primary carrier.

11. The fuel reformer as claimed in claim 10, wherein said first primary carrier includes at least one projection extended upwardly into said chamber thereof and secured to said cover.
